(19) United States
(12) Patent Application Publication
(10) Pub. No.: US 2023/0288080 A1
(43) Pub. Date: Sep. 14, 2023

(54) AIR PURIFIER AND FILTER STRUCTURE THEREOF

(71) Applicant: POWER LOGIC (JIANGXI TAI YI) CO., LTD., Ji'an City (CN)

(72) Inventors: Wen-Faung HSU, New Taipei City (TW); Chia-Heng HSU, New Taipei City (TW); Tai-Yu CHIU, New Taipei City (TW); Hsin-Ting CHUNG, New Taipei City (TW); Chung-Lin HSIEH, New Taipei City (TW)

(21) Appl. No.: 17/694,569

(22) Filed: Mar. 14, 2022

(51) Int. Cl. F24F 3/16; F24F 13/28; B01D 46/10; B01D 46/00

(52) U.S. Cl. CPC F24F 3/16; B01D 46/0005; B01D 46/103; F24F 13/28

(57) ABSTRACT

A filter structure includes a base and a filter. The base is provided with an aperture and multiple second slopes around the aperture. The filter is connected to the base and slidable relative to the base. The filter has a first sliding block and multiple second sliding blocks. The first sliding block passes through the aperture. Each second sliding block abuts against each second slope and is slidable along each second slope. Therefore, the gap between the main body and the filter may be reduced to increase the filtering efficiency of the air purifier and the filter structure.

### BACKGROUND

### Technical Field

The disclosure relates to an air purifying structure, particularly to an air purifier and a filter structure thereof.

### Related Art

A related-art air purifier includes a main body, a fan, and a filter. The fan guides air to be sucked through the filter to form clean air. Finally, the clean air is ejected from the main body so that the air purifier has functions of filtering dirt and increasing air cleanness.

However, there is a gap between the main body and the filter. This causes part of air to be directly sucked through the gap without passing the filter. Finally, the unfiltered air is ejected from the main body to considerably reduce the filtering effect of the air purifier.

In view of this, the inventors have devoted themselves to the above-mentioned related art, researched intensively and cooperated with the application of science to try to solve the above-mentioned problems. Finally, the disclosure which is reasonable and effective to overcome the above drawbacks is provided.

### SUMMARY

The disclosure provides an air purifier and a filter structure thereof, which use both the first sliding block to be raised along the first slope and each second sliding block to be raised along each second slope to make the filter be raised for being closely connected with the main body, when the filter structure is being embedded in the main body. This reduces the gap between the main body and the filter to increase the filtering efficiency of the air purifier and the filter structure.

In an embodiment of the disclosure, the disclosure provides an air purifier, which includes: a main body, provided with a recess and a first slope formed on a bottom of the recess, the recess having an opening, and the first slope gradually rising toward a direction away from the opening; and a filter structure, embedded in the recess, and including: a base, provided with an aperture and multiple second slopes disposed around the aperture, and the first slope and each second slope being opposite in slant direction; and a filter, connected to the base and slidable relative to the base, having a first sliding block and multiple second sliding blocks, the first sliding block passing through the aperture to abut against the first slope and slidable along the first slope, and each second sliding block abutting against each second slope and slidable along each second slope.

In an embodiment of the disclosure, the disclosure provides a filter structure, which includes: a base, provided with an aperture and multiple second slopes around the aperture; and a filter, connected to the base and slidable relative to the base, having a first sliding block and multiple second sliding blocks, the first sliding block passing through the aperture, and each second sliding block abutting against each second slope and slidable along each second slope.

Accordingly, the disclosure uses both the first sliding block to slide and rise along the first slope and each second sliding block to slide and rise along each second slope to make the filter be raised for being closely connected with the main body, when the filter structure is being embedded into the main body. This reduces the gap between the main body and the filter to make the air ejected from the air outlet of the main body indeed filtered by the filter to increase the filtering efficiency of the air purifier and the filter structure.

Accordingly, the multiple second sliding blocks are used to evenly disperse the weight of the filter born by the first sliding block to make the filter smoothly rise relative to the base while the filter structure is being embedded in the recess.

### BRIEF DESCRIPTION OF THE DRAWINGS

FIG. 1 is a perspective assembled view of the air purifier of the disclosure;

FIG. 2 is an exploded view of the air purifier of the disclosure;

FIG. 3 is another exploded view of the air purifier of the disclosure;

FIG. 4 is an exploded view of the filter structure of the disclosure;

FIG. 5 is an assembled cross-sectional view of the air purifier of the disclosure;

FIG. 6 is a schematic view of a using status of the air purifier of the disclosure; and

FIG. 7 is a schematic view of another using status of the air purifier of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

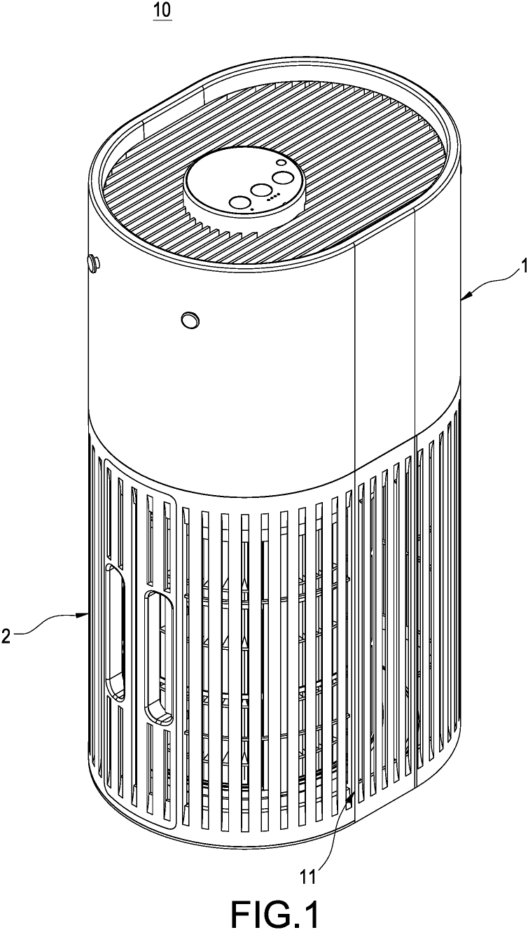

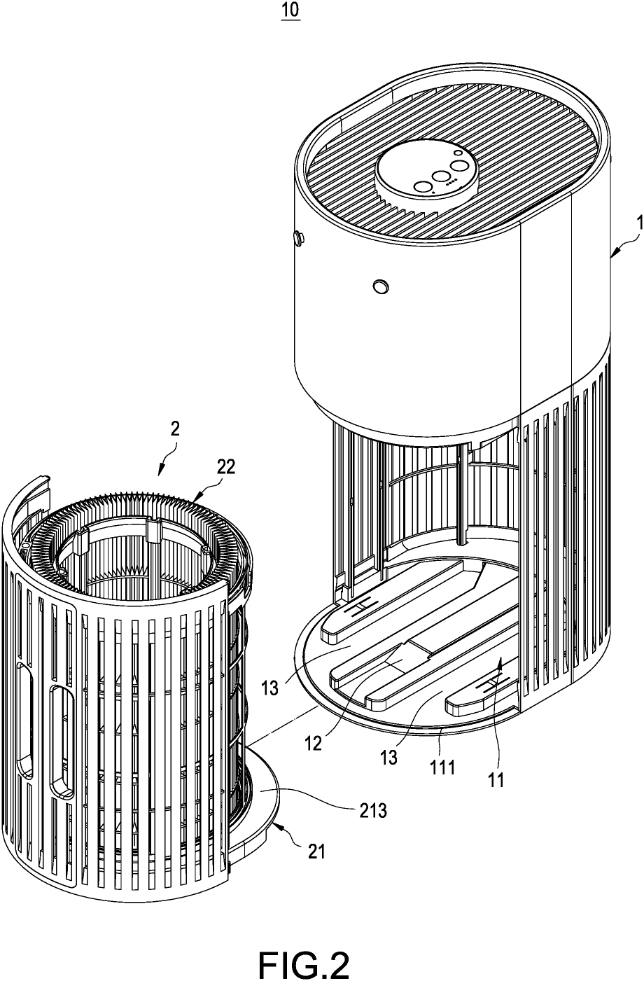

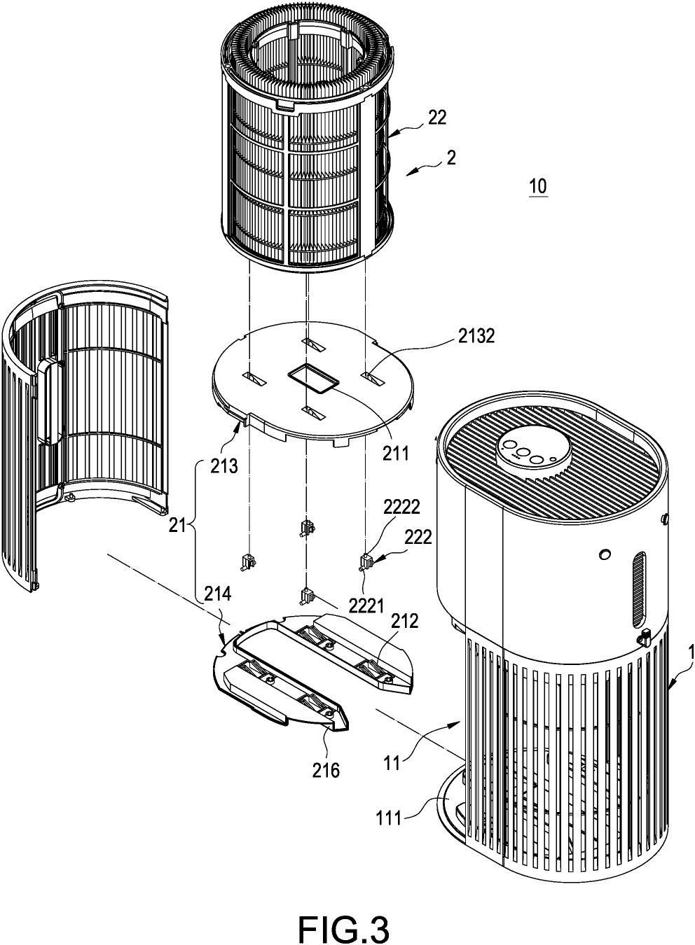

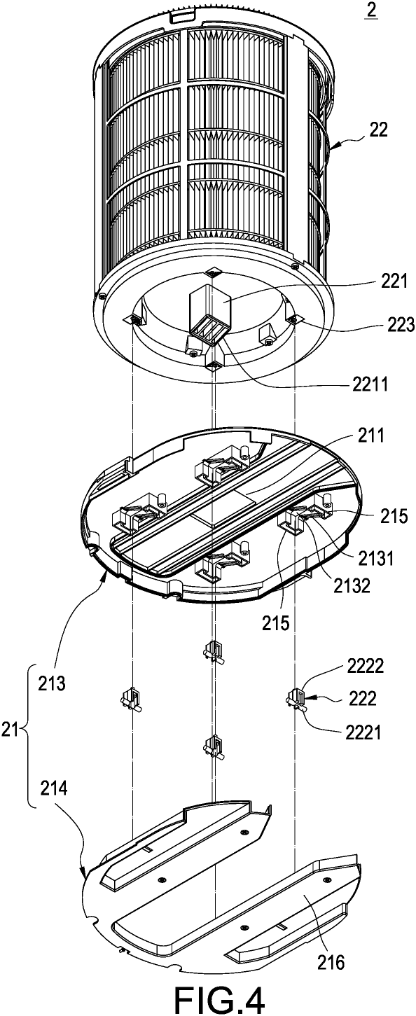

Please refer to FIGS. 1-7. The disclosure provides an air purifier and a filter structure thereof. The air purifier 10 includes a main body 1 and a filter structure 2. The filter structure 2 includes a base 21 and a filter 22.

As shown in FIGS. 1-3 and 5-7, the main body 1 is provided with a recess 11, a fan (not shown in figures) disposed over the recess 11 and air outlet (not shown in figures) disposed over the fan. The main body 1 further has a first slope 12 formed on the bottom of the recess 11 and multiple rails 13 formed on the bottom of the recess 11. The recess 11 is formed with an opening 111. The first slope 12 gradually rises toward a direction away from the opening 111.

As shown in FIGS. 1-7, the filter structure 2 may be embedded in or separated from the recess 11. The filter structure 2 includes a base 21 and a filter 22. The base 21 is provided with an aperture 211 and multiple second slopes 212 disposed around the aperture 211. The multiple second slopes 212 are arranged parallelly around the aperture 211 at regular intervals. The first slope 12 and each second slope 212 are opposite in slant direction.

In detail, the filter 22 is connected to the base 21 and slidable relative to the base 21. The filter 22 has a first sliding block 221 and multiple second sliding blocks 222. The first sliding block 221 passes through the aperture 211 to abut against (or reach) the first slope 12 and is slidable along the first slope 12. Each second sliding block 222 abuts against each second slope 212 and is slidable along each second slope 212.

In addition, the underside of the first sliding block 221 has a slant bottom 2211. The slant bottom 2211 reaches the first slope 12 and is opposite to the first slope 12 in slant direction. The slant bottom 2211 is slidable relative to the first slope 12.

In addition, an end of the first sliding block 221 has a transverse round rod 2221. The base 21 includes an upper base 213 and a lower base 214 connected vertically with each other. The bottom of the upper base 213 is protruded with multiple third slopes 2131. The multiple second slopes 212 protrude from the top of the lower base 214. Each second slope 212 is opposite to each third slope 2131 in slant direction. Each transverse round rod 2221 is sandwiched between each second slope 212 and each third slope 2131 and is slidable along each second slope 212.

Also, each first sliding block 221 is removably connected to the filter 22. In detail, another end of each first sliding block 221 has a fixing element 2222. Each third slope 2131 is formed with a through hole 2132. The filter 22 is formed with multiple fixing holes 223. Each fixing element 2222 passes through each through hole 2132 and is fixed in each fixing hole 223 to make the filter 22 be removably installed on the base 21. The fixing element 2222 may be, but not limited to, a fastener, a plug or a screw, etc.

Besides, at least one of the upper base 213 and the lower base 214 is extended with multiple stopping blocks 215 which are disposed on two sides of each second slope 212 and configured to stop each transverse round rod 2221. The bottom of the base 21 is protruded with multiple protrusions 216 which are slidable on the multiple rails 13. The multiple second slopes 212 and the multiple third slopes 2131 are disposed in the multiple protrusions 216.

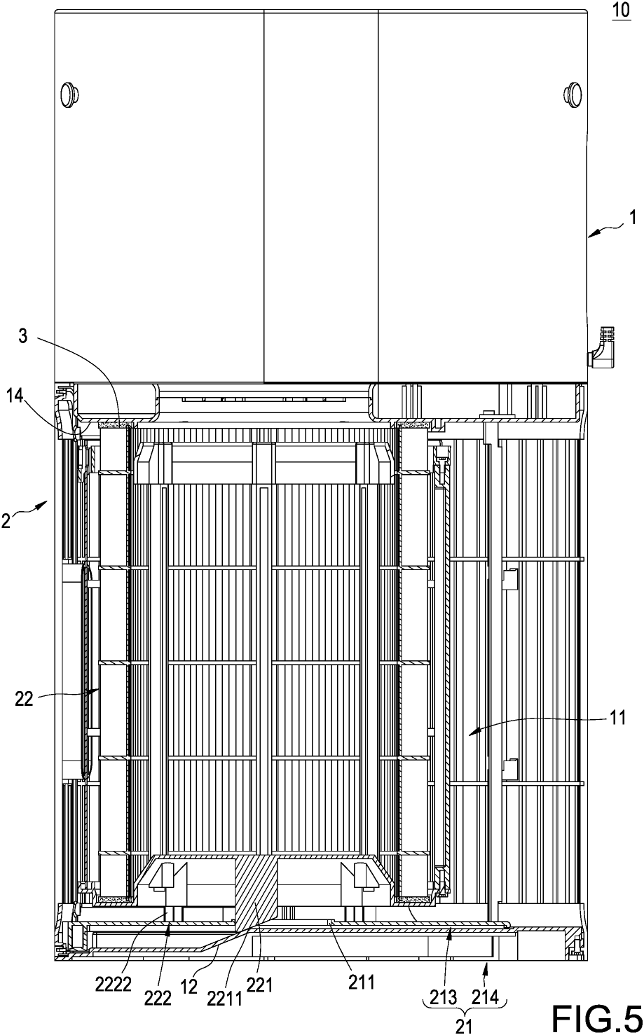

As shown in FIGS. 5-7, the air purifier 10 further includes a pad 3. The main body 1 has a top side 14 formed on the top of the recess 11. The pad 3 is fixed on the top side 14 and may be sandwiched between the main body 1 and the filter 22.

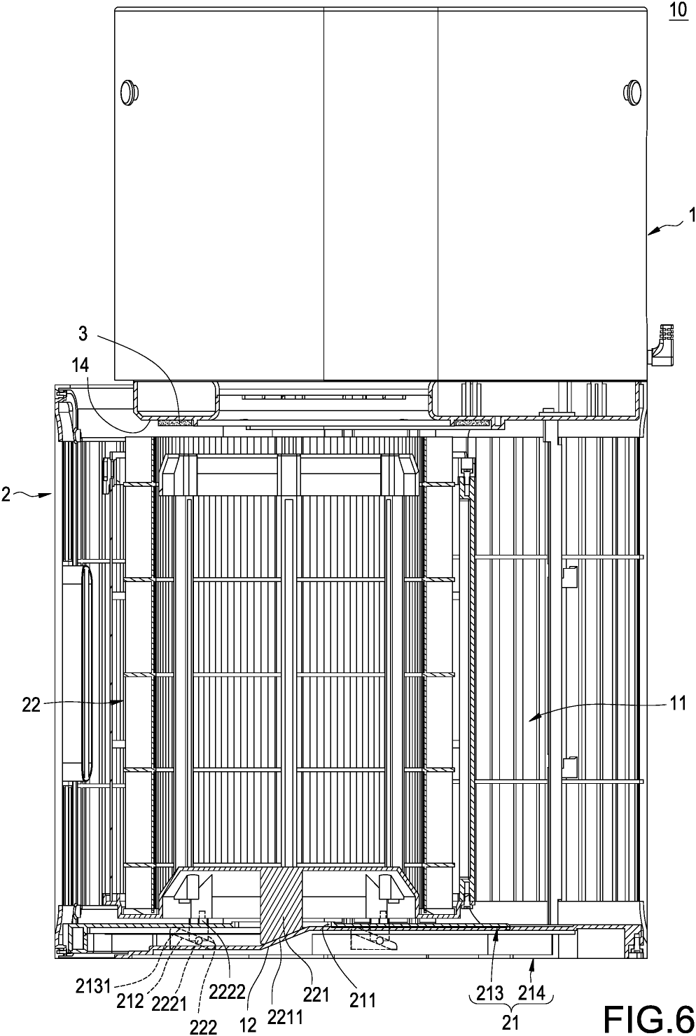

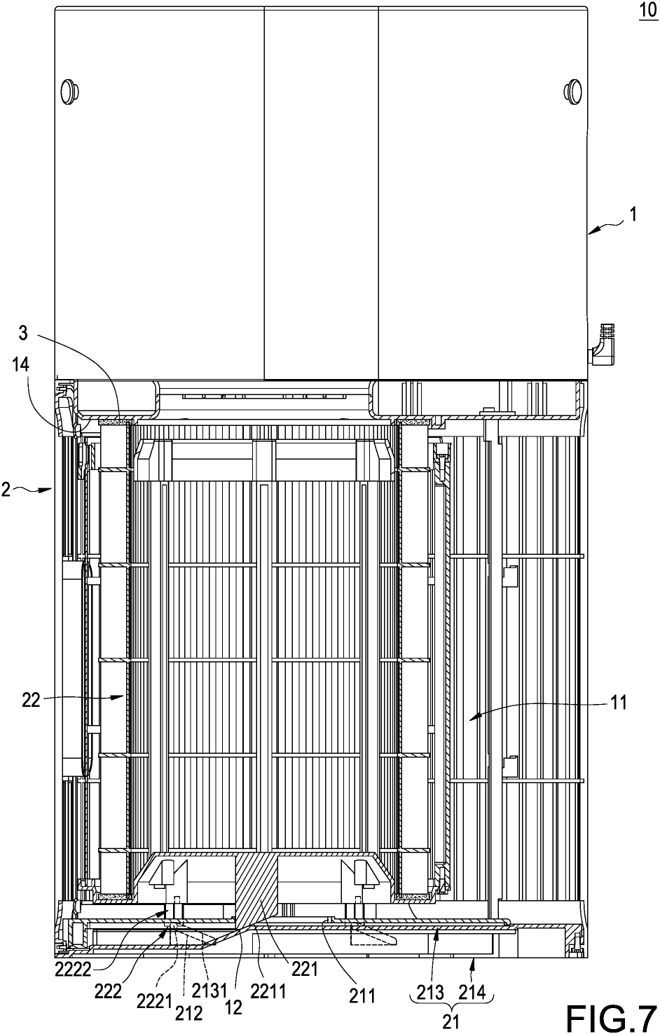

As shown in FIGS. 6-7, which show the using statuses of the air purifier 10 of the disclosure, the disclosure uses both the first sliding block 221 to slide and rise along the first slope 12 and each second sliding block 222 to slide and rise along each second slope 212 to make the filter 22 be raised for being closely connected with the main body 1 when the filter structure 2 is being embedded into the main body 1. This reduces the gap between the main body 1 and the filter 22 to make the air ejected from the air outlet of the main body 1 indeed filtered by the filter 22 to increase the filtering efficiency of the air purifier 10 and the filter structure 2.

In addition, the multiple second sliding blocks 222 are used to evenly disperse the weight of the filter 22 bom by the first sliding block 221 to make the filter 22 smoothly rise relative to the base 21 while the filter structure 2 is being embedded in the recess 11.

Further, the top side 14 formed on the top of the recess 11 of the main body 1 is fixed with the pad 3. The filter 22 rises relative to the base 21 to reach the pad 3 to make the pad 3 be sandwiched between the main body 1 and the filter 22 while the filter structure 2 is being embedded in the recess 11. This avoids a gap formed between the main body 1 and the filter 22.

While this disclosure has been described by means of specific embodiments, numerous modifications and variations could be made thereto by those skilled in the art without departing from the scope and spirit of this disclosure set forth in the claims.

What is claimed is:

1. An air purifier comprising:
a main body, comprising a recess and a first slope disposed on a bottom of the recess, the recess comprising an opening, and the first slope gradually rising toward a direction away from the opening; and
a filter structure, embedded in the recess, and comprising:
a base, comprising an aperture and multiple second slopes disposed around the aperture, and the first slope and each second slope being opposite in slant direction; and
a filter, connected to the base and slidable relative to the base, comprising a first sliding block and multiple second sliding blocks, the first sliding block passing through the aperture to abut against the first slope and slidable along the first slope, and each second sliding block abutting against each second slope and slidable along each second slope.

2. The air purifier of claim 1, wherein the first sliding block comprises a transverse round rod disposed on one end thereof, the base comprises an upper base and a lower base connected vertically with each other, the upper base comprises multiple third slopes disposed protrusively on a bottom thereof, the multiple second slopes protrude from a top of the lower base, each second slope is opposite to each third slope in slant direction, and each transverse round rod is sandwiched between each second slope and each third slope and slidable along each second slope.

3. The air purifier of claim 2, wherein at least one of the upper base and the lower base comprises multiple stopping blocks extensively disposed on two sides of each second slope and configured to stop each transverse round rod.

4. The air purifier of claim 2, wherein the first sliding block is removably connected to the filter, the first sliding block comprises a fixing element disposed on another end thereof, a through hole is defined on each third slope, multiple fixing holes are defined on the filter, and each fixing element passes through each through hole and is fixed in each fixing hole.

5. The air purifier of claim 2, wherein the main body comprises multiple rails disposed on the bottom of the recess, the base comprises multiple protrusions disposed protrusively on a bottom thereof and slidable on the multiple rails, and the multiple second slopes and the multiple third slopes are disposed in the multiple protrusions.

6. The air purifier of claim 1, wherein the first sliding block comprises a slant bottom disposed on an underside thereof, and the slant bottom abuts against the first slope and is opposite to the first slope in slant direction.

7. The air purifier of claim 1, further comprising a pad, wherein the main body comprises a top side disposed on a top of the recess, and the pad is fixed on the top side and sandwiched between the main body and the filter.

8. A filter structure comprising:
a base, comprising an aperture and multiple second slopes disposed around the aperture; and
a filter, connected to the base and slidable relative to the base, comprising a first sliding block and multiple second sliding blocks, the first sliding block passing through the aperture, and each second sliding block abutting against each second slope and slidable along each second slope.

9. The filter structure of claim 8, wherein the first sliding block comprises a transverse round rod disposed on one end thereof, the base comprises an upper base and a lower base connected vertically with each other, the upper base comprises multiple third slopes disposed protrusively on a bottom thereof, the multiple second slopes protrude from a top of the lower base, each second slope is opposite to each third slope in slant direction, and each transverse round rod is sandwiched between each second slope and each third slope and slidable along each second slope.

10. The filter structure of claim 9, wherein at least one of the upper base and the lower base comprises multiple stopping blocks disposed extensively on two sides of each second slope and configured to stop each transverse round rod.

11. The filter structure of claim 9, wherein the first sliding block is removably connected to the filter, the first sliding block comprises a fixing element disposed on another end thereof, a through hole is defined on each third slope, multiple fixing holes are defined on the filter, and each fixing element passes through each through hole and is fixed in each fixing hole.
